(19) United States
(12) Patent Application Publication
(10) Pub. No.: US 2023/0236489 A1
(43) Pub. Date: Jul. 27, 2023

(54) LIGHT SOURCE DEVICE AND IMAGE PROJECTING APPARATUS

(71) Applicant: CANON KABUSHIKI KAISHA, Tokyo (JP)

(72) Inventor: Yuuki MAEDA, Tochigi (JP)

(21) Appl. No.: 18/145,100

(22) Filed: Dec. 22, 2022

(30) Foreign Application Priority Data
Jan. 24, 2022 (JP) 2022-008451

(51) Int. Cl. G03B 21/20; G02B 27/14

(52) U.S. Cl. CPC G03B 21/204; G03B 21/2013; G03B 21/2066; G02B 27/141

(57) ABSTRACT

The light source device includes a light source emitting a first light, a wavelength conversion element emitting a second light with a different wavelength from the first light by an incidence of the first light, a first optical system guiding the first light from the light source to the wavelength conversion element and including a reflecting element which reflects the first light with condensing it, and a second optical system exerting an optical action on the second light from the wavelength conversion element. The light source device satisfies the following conditional expression:

3≤α≤30

where α [degrees] represents an angle between an optical axis of the second optical system and a straight line passing through an intersection point between the optical axis of the second optical system and an exit surface of the wavelength conversion element, and a focal point of the reflecting element.

### BACKGROUND OF THE INVENTION

### Field of the Invention

The present invention is related to a light source device and an image projecting apparatus including the light source device.

### Description of the Related Art

Conventionally, there has been known a light source device which uses, as illumination light, fluorescent light generated by making laser light incident on a fluorescent body and then condensed by a condensing lens.

Japanese Patent Application Laid-Open No. 2019-160624 discloses a light source device in which a light condensing efficiency according to a condensing lens of fluorescent light generated by a fluorescent body is improved by employing such a structure that laser light is incident on the fluorescent body through a gap between the condensing lens and the fluorescent body, and narrowing the gap.

The light source device disclosed in Japanese Patent Application Laid-Open No. 2019-160624 is increased in size since it is necessary to secure a sufficient gap between the condensing lens and the fluorescent body in order to make laser light incident on the fluorescent body so as not to interfere with the condensing lens.

### SUMMARY OF THE INVENTION

Accordingly, an object of the present invention is to provide a light source device which can be downsized with maintaining a high utilization efficiency of fluorescent light.

The light source device according to the present invention includes a first light source configured to emit a first light, a wavelength conversion element configured to emit a second light with a wavelength different from the wavelength of the first light when the first light is incident on the wavelength conversion element, a first optical system configured to guide the first light from the first light source to the wavelength conversion element and including a first reflecting element configured to reflect the first light with condensing the first light, and a second optical system configured to exert an optical action on the second light from the wavelength conversion element. The light source device according to the present invention satisfies the following conditional expression:

3≤α≤30

where α [degrees] represents an angle between an optical axis of the second optical system and a straight line passing through an intersection point between the optical axis of the second optical system and an exit surface of the wavelength conversion element, and a focal point of the first reflecting element.

Further features of the present invention will become apparent from the following description of exemplary embodiments with reference to the attached drawings.

### BRIEF DESCRIPTION OF THE DRAWINGS

FIG. 1 is a schematic cross-sectional view of an image projecting apparatus including a light source device according to a first embodiment of the present invention.

FIG. 2 is a plan view of a second collimator lens provided in the light source device according to the first embodiment.

FIG. 3 is a schematic cross-sectional view for explaining each angle in the light source device according to the first embodiment.

FIG. 4 is a schematic cross-sectional view of a light source device according to a second embodiment of the present invention.

FIG. 5 is a schematic cross-sectional view of a light source device according to a third embodiment of the present invention.

FIG. 6 is a schematic cross-sectional view of a light source device according to a fourth embodiment of the present invention.

FIG. 7 is a schematic cross-sectional view of a light source device according to a fifth embodiment of the present invention.

### DESCRIPTION OF THE EMBODIMENTS

Hereinafter, a light source device according to the present invention is described in detail with reference to the accompanying drawings. The drawings described below may be drawn on a scale different from the actual scale in order to facilitate understanding of the present invention.

### First Embodiment

In recent years, a light source device has been developed which uses, as illumination light, fluorescent light generated by a fluorescent body on which laser light serving as excitation light is incident.

As such light source device, there is known a light source device in which laser light is made incident on a fluorescent body provided with a cooling member from a side opposite to the cooling member to use generated fluorescent light as illumination light.

Further, there is known a light source device in which a light condensing efficiency according to a condensing lens of fluorescent light generated by a fluorescent body is improved by employing such a structure that laser light is incident on the fluorescent body through a gap between the condensing lens and the fluorescent body, and narrowing the gap.

However, in such light source device, it is necessary to secure a sufficient gap between the condensing lens and the fluorescent body in order to make laser light incident on the fluorescent body so as not to interfere with the condensing lens, so that the light source device is increased in size.

In addition, when an attempt is made to secure the sufficient gap, it becomes difficult to condense the fluorescent light emitted from the fluorescent body at a high angle by the condensing lens.

Further, since the laser light is incident on the fluorescent body at a high angle from the gap, a condensing spot on the fluorescent body is distorted, and a light emission efficiency of the fluorescent light by the fluorescent body and a utilization efficiency of the fluorescent light in a subsequent optical system including the condensing lens are decreased.

Furthermore, there is known a light source device in which a light condensing efficiency according to a condensing lens of fluorescent light generated by a fluorescent body is improved by narrowing a gap between the condensing lens and the fluorescent body and causing laser light to pass through a through-hole formed in the condensing lens to be incident on the fluorescent body.

However, in such light source device, the fluorescent light incident on the condensing lens is scattered by the through-hole, so that the light condensing efficiency by the condensing lens of the fluorescent light is decreased.

Accordingly, an object of the present embodiment is to provide a compact light source device capable of achieving a high light condensing efficiency, and an image projecting apparatus including the light source device.

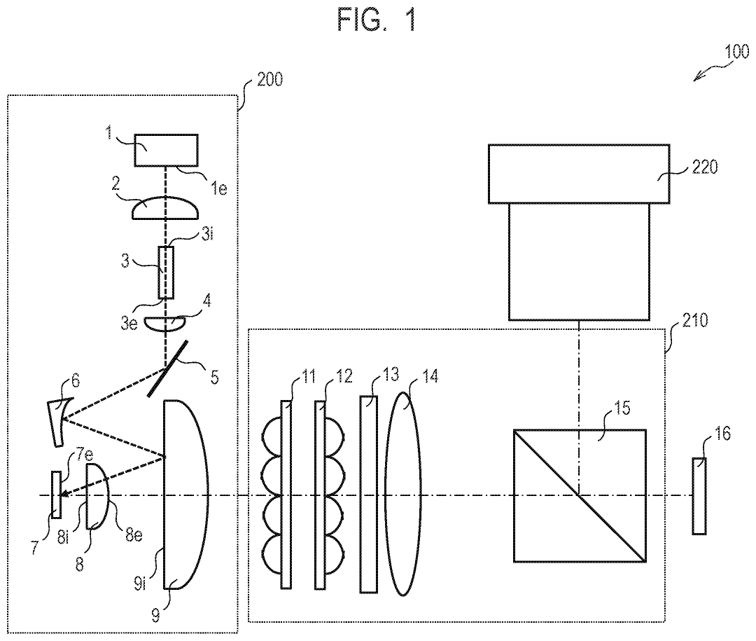

FIG. 1 shows a schematic cross-sectional view of an image projecting apparatus 100 including a light source device 200 according to a first embodiment of the present invention.

As shown in FIG. 1, the image projecting apparatus 100 includes a liquid crystal panel 16 (an image displaying element), the light source device 200, an illuminating optical system 210 and a projecting lens 220 (a projecting optical system).

The light source device 200 according to the present embodiment includes an LD unit 1, a first lens 2, a rod integrator 3, a second lens 4, a flat mirror 5, an aspherical mirror 6, a fluorescent body unit 7, a first collimator lens 8 and a second collimator lens 9.

The LD unit 1 (a first light source) includes a plurality of laser diodes (LDs) and a plurality of collimator lenses (not illustrated), and is configured to emit a plurality of blue light beams, namely a blue light flux (a first light flux).

The LD unit 1 may include a plurality of light emitting diodes (LEDs), a mercury lamp or the like instead of the plurality of laser diodes.

The first lens 2 is configured to condense the blue light flux emitted from the LD unit 1 on an incident surface 3i of the rod integrator 3.

The rod integrator 3 is configured to make an intensity distribution of the blue light flux uniform by allowing the blue light flux condensed by the first lens 2 to pass therethrough.

The second lens 4 is configured to convert a divergent light flux exited from an exit surface 3e of the rod integrator 3 into a parallel light flux.

The flat mirror 5 (a second reflecting element) is configured to reflect the parallel light flux passing through the second lens 4 toward the aspherical mirror 6. Note that a curved mirror may be provided instead of the flat mirror 5.

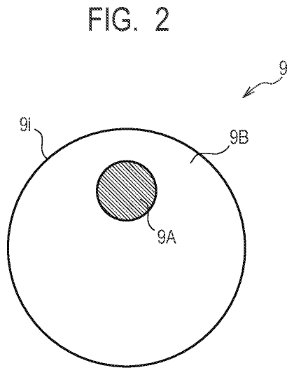

The aspherical mirror 6 (a first reflecting element) has a reflecting surface in an aspherical shape with a positive power (a refractive power), and is configured to reflect the parallel light flux reflected by the flat mirror 5 toward a first region 9A (FIG. 2) on an incident surface 9i of the second collimator lens 9 with condensing the parallel light flux.

On the incident surface 9i of the second collimator lens 9, a color separating means (a color separator) having at least the first region 9A and a second region 9B (FIG. 2) which are shared by a first optical system and a second optical system described later, is provided. In other words, the color separating means is provided on the surface at the fluorescent body unit 7 side of the second collimator lens 9.

FIG. 2 shows a plan view of the incident surface 9i of the second collimator lens 9 provided with the color separating means.

The first region 9A of the color separating means is a region on which blue light flux reflected by the aspherical mirror 6 is incident, and a dichroic film having a characteristic of reflecting blue light and transmitting fluorescent light from the fluorescent body unit 7 is deposited thereon.

Further, on the second region 9B of the color separating means, an antireflection film having a characteristic of transmitting visible light including at least the fluorescent light from the fluorescent body unit 7 and the blue light is deposited.

As shown in FIG. 1, the blue light flux incident on the incident surface 9i of the second collimator lens 9 from the aspherical mirror 6 is reflected by the above-described structure.

Then, the blue light flux reflected by the incident surface 9i of the second collimator lens 9 passes from an exit surface 8e to an incident surface 8i of the first collimator lens 8 to be condensed on the fluorescent body unit 7.

Thereby, a predetermined rectangular image is formed on the fluorescent body unit 7 by optical actions of the rod integrator 3, the aspherical mirror 6 and the first collimator lens 8.

The fluorescent body unit 7 is an element in which a fluorescent body layer is coated on a substrate, and a reflection film for reflecting fluorescent light is deposited between the substrate and the fluorescent body layer.

With the above-described structure, the fluorescent body unit 7 absorbs a part of the blue light flux emitted from the LD unit 1 to emit a fluorescent light flux (a second light flux) having a wavelength different from that of the blue light flux.

In other words, the fluorescent body unit 7 is a wavelength conversion element configured to convert at least a part of the blue light emitted from the LD unit 1 into fluorescent light having a wavelength different from that of the blue light.

In still other words, the fluorescent body unit 7 is a wavelength conversion element configured to emit a fluorescent light flux having a wavelength different from that of the blue light flux when the blue light flux is incident thereon.

As the substrate of the fluorescent body unit 7, a metal plate having a high thermal conductivity such as aluminum or copper, or a transparent substrate having a high thermal conductivity such as a sapphire substrate can be used.

Further, the fluorescent body unit 7 does not need to be fixed in the light source device 200, and may be configured to be rotated around a rotation axis perpendicular to an emitting surface 7e of the fluorescent body unit 7 by a motor or the like.

Furthermore, the fluorescent body unit 7 is configured to diffusely reflect a part of the blue light flux from the LD unit 1.

The first collimator lens 8 and the second collimator lens 9 are configured to convert the fluorescent light flux and the blue light flux from the fluorescent body unit 7 into parallel light fluxes.

Thereby, the fluorescent light flux emitted from the fluorescent body unit 7 is converted into a parallel light flux by passing through the first collimator lens 8 and the second collimator lens 9 to be incident on the illuminating optical system 210.

Further, the blue light flux diffusely reflected by the fluorescent body unit 7 is converted into a parallel light flux by passing through the first collimator lens 8 and the second region 9B of the second collimator lens 9 to be incident on the illuminating optical system 210.

In the light source device 200 according to the present embodiment, a first optical system is formed by the first lens 2, the rod integrator 3, the second lens 4, the flat mirror 5, the aspherical mirror 6, the second collimator lens 9 and the first collimator lens 8.

The first optical system is configured to condense (guide) the blue light flux emitted from the LD unit 1 onto the fluorescent body unit 7.

Further, in the light source device 200 according to the present embodiment, a second optical system is formed by the first collimator lens 8 and the second collimator lens 9.

The second optical system is configured to exert an optical action on the fluorescent light flux and the blue light flux from the fluorescent body unit 7, specifically convert the fluorescent light flux and the blue light flux into parallel light fluxes.

The illuminating optical system 210 includes a first fly-eye lens 11, a second fly-eye lens 12, a PS conversion element 13, a condensing lens 14 and a polarization beam splitter (hereinafter referred to as “PBS”) 15.

The first fly-eye lens 11 and the second fly-eye lens 12 form an integrator system, and are configured to guide the fluorescent light flux and the blue light flux incident on the illuminating optical system 210 to the PS conversion element 13.

The PS conversion element 13 is configured to convert each polarization of the fluorescent light flux and the blue light flux which have passed through the first fly-eye lens 11 and the second fly-eye lens 12 into P-polarization.

The condensing lens 14 is configured to condense the fluorescent light flux and the blue light flux which have passed through the PS conversion element 13.

The PBS 15 is configured to transmit the P-polarized fluorescent light flux and the P-polarized blue light flux which have passed through the condensing lens 14 toward the liquid crystal panel 16.

Further, the PBS 15 is configured to reflect image light reflected and converted from P-polarized into S-polarized by the liquid crystal panel 16 toward the projecting lens 220.

Thereby, the fluorescent light flux and the blue light flux incident on the illuminating optical system 210 are guided to the liquid crystal panel 16 via the first fly-eye lens 11, the second fly-eye lens 12, the PS conversion element 13, the condensing lens 14 and the PBS 15 to illuminate the liquid crystal panel 16.

Then, the image light from the liquid crystal panel 16 is incident on the projecting lens 220 via the PBS 15 to be projected (guided) onto a screen (a projected surface) (not illustrated).

Next, a specific structure of the light source device 200 according to the present embodiment is described.

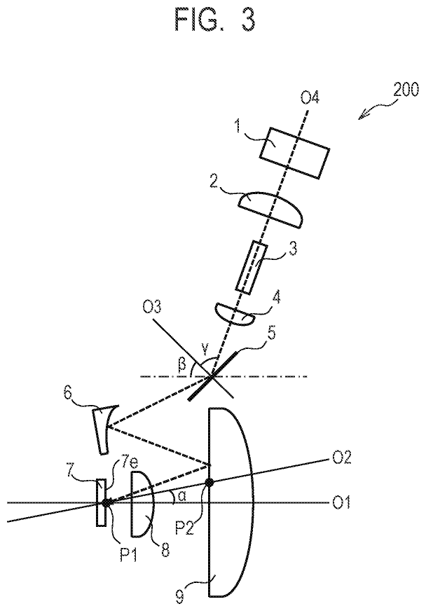

FIG. 3 shows a schematic cross-sectional view for explaining each angle in the light source device 200 according to the present embodiment.

As shown in FIG. 3, an intersection point between an optical axis O1 of the second optical system and the emitting surface 7e of the fluorescent body unit 7 is represented by P1.

Further, a condensed point of paraxial rays by the aspherical mirror 6, namely a focal point of the aspherical mirror 6 is represented by P2. Although FIG. 3 shows a case where the focal point P2 of the aspherical mirror 6 is located at a position on the surface at the fluorescent body unit 7 side of the second collimator lens 9, the present invention is not limited to this, namely the focal point P2 can be located at various positions.

Furthermore, an axis (a straight line) passing through the points P1 and P2 is defined as an optical axis O2 of the aspherical mirror 6.

Here, an angle (an acute angle) between the optical axis O1 of the second optical system and the optical axis O2 of the aspherical mirror 6 is represented by α [degrees].

At this time, in the light source device 200 according to the present embodiment, the following conditional expression (1) is satisfied:

3≤α≤30 (1).

If the value falls below the lower limit value in the conditional expression (1), it is necessary to largely separate the aspherical mirror 6 from each of the flat mirror 5 and the second collimator lens 9 in order to separate a light flux incident on the aspherical mirror 6 and the light flux exiting from the aspherical mirror 6 from each other. This increases a size of the apparatus, which is not preferable.

On the other hand, if the value exceeds the upper limit value in the conditional expression (1), an aberration of the first optical system deteriorates, so that it becomes difficult to form the predetermined rectangular image on the fluorescent body unit 7, which is not preferable.

In the light source device 200 according to the present embodiment, it is preferred that the following conditional expression (1a) is satisfied:

5≤α≤20 (1a).

Next, an angle (an acute angle) between a normal line O3 of the reflecting surface of the flat mirror 5 and the optical axis O1 of the second optical system is represented by β [degrees].

Here, the normal line O3 of the reflecting surface of the flat mirror 5 can be also defined as an optical axis O3 of the flat mirror 5. When a curved mirror is used instead of the flat mirror 5, an optical axis of the curved mirror can be defined as the optical axis O3.

Further, an angle (an acute angle) between an optical axis O4 of the second lens 4, in other words, an axis O4 parallel to an incident direction of the blue light flux from the LD unit 1 on the flat mirror 5, and the normal line O3 of the reflecting surface of the flat mirror 5 is represented by γ [degrees].

At this time, in the light source device 200 according to the present embodiment, it is preferred that the following conditional expression (2) is satisfied:

γ−2α−10≤β≤γ−2α+10 (2).

In order to efficiently use fluorescent light in the image projecting apparatus 100, it is preferred that the first optical system and the second optical system are coaxial with each other in the light source device 200 according to the present embodiment.

That is, if the value exceeds the upper limit value or falls below the lower limit value in the conditional expression (2), an image plane formed on the fluorescent body unit 7 by the first optical system in the light source device 200 according to the present embodiment is inclined with respect to an image plane of the second optical system, so that a utilization efficiency of the fluorescent light decreases, which is not preferable.

In the light source device 200 according to the present embodiment, it is more preferred that the following conditional expression (2a) is satisfied:

γ−2α−5≤β≤γ−2α+5 (2).

Next, a focal length of the first lens 2 is represented by f1, and a focal length of the second lens 4 is represented by f2.

At this time, in the light source device 200 according to the present embodiment, it is preferred that the following conditional expression (3) is satisfied:

$$0.05 \leq \frac{f 2}{f 1} \leq 0.6 . \qquad ( 3 )$$

If the ratio exceeds the upper limit value in the conditional expression (3), it is necessary to largely separate the aspherical mirror 6 from each of the flat mirror 5 and the second collimator lens 9 in order to separate a light flux incident on the aspherical mirror 6 and the light flux exiting from the aspherical mirror 6 from each other. This increases a size of the apparatus, which is not preferable.

On the other hand, if the ratio falls below the lower limit value in the conditional expression (3), an angular magnification becomes too large, so that a degree of parallelization when a light flux incident on the second lens 4 is converted into a parallel light flux deteriorates, which is not preferable.

Further, if the second lens 4 converts an incident light flux into a parallel light flux at a short interval with respect to the first lens 2 such that the ratio falls below the lower limit value in the conditional expression (3), a curvature radius of the second lens 4 becomes too small. As a result, a large spherical aberration is generated, so that the degree of parallelization when the light flux incident on the second lens 4 is converted into the parallel light flux deteriorates, which is not preferable.

In the light source device 200 according to the present embodiment, it is more preferred that the following conditional expression (3a) is satisfied:

$$0.1 \leq \frac{f 2}{f 1} \leq 0.4 . \qquad ( 3 a )$$

As described above, in the light source device 200 according to the present embodiment, it is possible to achieve downsizing with maintaining a high utilization efficiency of fluorescent light by employing the above-described structure satisfying at least the conditional expression (1).

In the light source device 200 according to the present embodiment, a dichroic film having a characteristic of reflecting blue light and transmitting fluorescent light is deposited on the incident surface 9i of the second collimator lens 9, but the present invention is not limited thereto.

That is, a dichroic mirror in which such dichroic film is deposited on a flat plate may be provided between the first collimator lens 8 and the second collimator lens 9.

Further, the LD unit 1 may be a light source configured to emit an ultraviolet light flux, and the fluorescent body unit 7 may be a fluorescent body configured to emit a white light flux when the ultraviolet light flux is incident thereon in the light source device 200 according to the present embodiment.

In this case, a dichroic film having a characteristic of reflecting ultraviolet light and transmitting white light is deposited on the first region 9A of the incident surface 9i of the second collimator lens 9.

Furthermore, an optical fiber may be used instead of the rod integrator 3 in the light source device 200 according to the present embodiment.

In addition, in the image projecting apparatus 100, a reflection-type liquid crystal panel is used as the liquid crystal panel 16, but a transmission-type liquid crystal panel or a micro-mirror device may be used instead.

### Second Embodiment

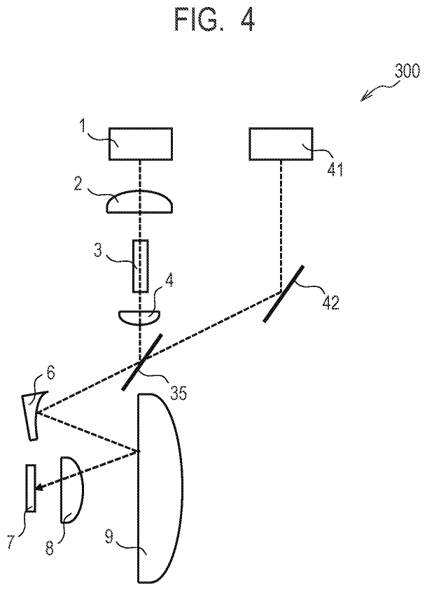

FIG. 4 shows a schematic cross-sectional view of a light source device 300 according to a second embodiment of the present invention.

The light source device 300 according to the present embodiment has the same structure as the light source device 200 according to the first embodiment except that an auxiliary light source 41 and a flat mirror 42 are newly provided, and a dichroic mirror 35 is provided instead of the flat mirror 5.

Therefore, in the following description, the same members as those of the light source device 200 according to the first embodiment are denoted by the same reference numerals, and a description thereof is omitted.

The auxiliary light source 41 (a second light source) includes a plurality of laser diodes (LDs) and a plurality of collimator lenses (not illustrated), and is configured to emit a plurality of infrared light beams, namely an infrared light flux (a third light flux).

That is, the auxiliary light source 41 is configured to emit the infrared light flux having a wavelength different from that of the blue light flux emitted from the LD unit 1.

The auxiliary light source 41 may include a plurality of light emitting diodes (LEDs), a mercury lamp or the like instead of the plurality of laser diodes.

Further, the auxiliary light source 41 may be configured to emit a green light flux or a red light flux instead of the infrared light flux, namely may be configured to emit a light flux in a wavelength range in which an absorption by the fluorescent body unit 7 is small.

The flat mirror 42 is configured to reflect the infrared light flux emitted from the auxiliary light source 41 toward the dichroic mirror 35.

The dichroic mirror 35 (a second reflecting element) is formed by depositing on a flat plate a dichroic film having a characteristic of reflecting the blue light flux from the LD unit 1 and transmitting the infrared light flux from the auxiliary light source 41.

The fluorescent body unit 7 is configured to absorb a part of the blue light flux emitted from the LD unit 1 and then emit a fluorescent light flux having a wavelength different from that of the blue light flux, and diffusely reflect a part of each of the incident blue light flux and the incident infrared light flux.

Further, in the first region 9A of the second collimator lens 9 on which the blue light flux from the LD unit 1 and the infrared light flux from the auxiliary light source 41 are incident, a dichroic film having a characteristic of reflecting blue light and infrared light and transmitting fluorescent light from the fluorescent body unit 7 is deposited.

In the light source device 300 according to the present embodiment, a first optical system is formed by the first lens 2, the rod integrator 3, the second lens 4, the dichroic mirror 35, the aspherical mirror 6, the second collimator lens 9 and the first collimator lens 8.

Further, a second optical system is formed by the first collimator lens 8 and the second collimator lens 9.

Furthermore, a third optical system is formed by the flat mirror 42, the dichroic mirror 35, the aspherical mirror 6, the second collimator lens 9 and the first collimator lens 8.

That is, the dichroic mirror 35 and the aspherical mirror 6 are shared by the first optical system and the third optical system.

Further, the first collimator lens 8 and the second collimator lens 9 are shared by the first optical system, the second optical system and the third optical system.

By the above-described structure, the blue light flux emitted from the LD unit 1 is condensed (guided) on the fluorescent body unit 7 by the first optical system in the light source device 300 according to the present embodiment.

Further, the infrared light flux emitted from the auxiliary light source 41 is condensed (guided) on the fluorescent body unit 7 by the third optical system.

Then, the fluorescent light flux emitted from the fluorescent body unit 7 is converted into a parallel light flux by passing through the second optical system to be incident on the illuminating optical system 210.

Further, the blue light flux and the infrared light flux diffusely reflected by the fluorescent body unit 7 are converted into parallel light fluxes by passing through the first collimator lens 8 and the second region 9B of the second collimator lens 9 to be incident on the illuminating optical system 210.

As described above, in the light source device 300 according to the present embodiment, it is possible to achieve downsizing with maintaining a high utilization efficiency of fluorescent light by employing the above-described structure satisfying at least the conditional expression (1).

Further, infrared light can also be made incident on the illuminating optical system 210 in addition to fluorescent light and blue light in the light source device 300 according to the present embodiment.

In the light source device 300 according to the present embodiment, it is possible to increase the utilization efficiency of the infrared light since the infrared light flux emitted from the auxiliary light source 41 is condensed on the fluorescent body unit 7 without passing through an integrator system including the rod integrator 3.

### Third Embodiment

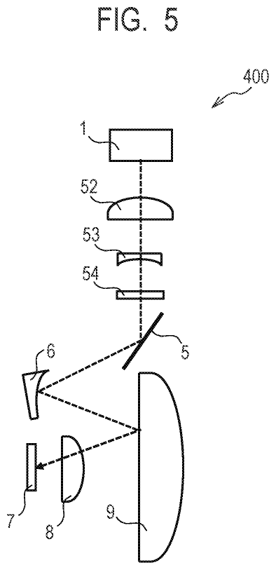

FIG. 5 shows a schematic cross-sectional view of a light source device 400 according to a third embodiment of the present invention.

The light source device 400 according to the present embodiment includes a first lens 52, a second lens 53 and a micro fly-eye lens 54 instead of the first lens 2, the rod integrator 3 and the second lens 4. The structure of the light source device 400 according to the present embodiment other than the above is the same as that of the light source device 200 according to the first embodiment.

Therefore, in the following description, the same members as those of the light source device 200 according to the first embodiment are denoted by the same reference numerals, and a description thereof is omitted.

The first lens 52 has a positive power and is configured to condense a blue light flux emitted from the LD unit 1.

The second lens 53 has a negative power and is configured to convert the blue light flux condensed by the first lens 52 into a parallel light flux.

The micro fly-eye lens 54 (a light diffusing element) is configured to diffuse the blue light flux which has passed through the second lens 53.

That is, the first lens 52 and the second lens 53 form a compression system, and guide the blue light flux emitted from the LD unit 1 to the micro fly-eye lens 54 as an integrator system with compressing it.

In the light source device 400 according to the present embodiment, a first optical system is formed by the first lens 52, the second lens 53, the micro fly-eye lens 54, the flat mirror 5, the aspherical mirror 6, the second collimator lens 9 and the first collimator lens 8.

In the light source device 400 according to the present embodiment, the blue light flux emitted from the LD unit 1 is condensed on the fluorescent body unit 7 by the first optical system by the above-described structure.

Then, the fluorescent light flux emitted from the fluorescent body unit 7 is converted into a parallel light flux by passing through the second optical system to be incident on the illuminating optical system 210.

Further, the blue light flux diffusely reflected by the fluorescent body unit 7 is converted into a parallel light flux by passing through the first collimator lens 8 and the second region 9B of the second collimator lens 9 to be incident on the illuminating optical system 210.

When a focal length of the first lens 52 is represented by f1, and a focal length of the second lens 53 is represented by f2, it is preferred that the above-described conditional expression (3) is satisfied, and it is more preferred that the above-described conditional expression (3a) is satisfied in the light source device 400 according to the present embodiment.

As described above, in the light source device 400 according to the present embodiment, it is possible to achieve downsizing with maintaining a high utilization efficiency of fluorescent light by employing the above-described structure satisfying at least the conditional expression (1).

In the light source device 400 according to the present embodiment, a diffusion plate or a computer generated hologram (CGH) may be used instead of the micro fly-eye lens 54.

### Fourth Embodiment

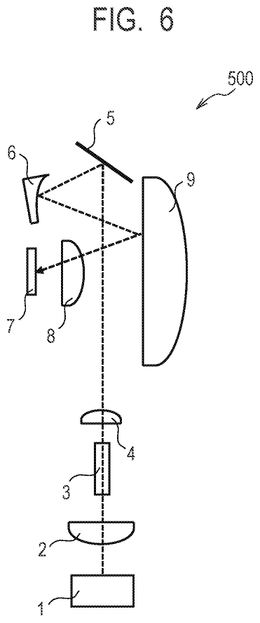

FIG. 6 shows a schematic cross-sectional view of a light source device 500 according to a fourth embodiment of the present invention.

Since the light source device 500 according to the present embodiment has the same structure as the light source device 200 according to the first embodiment except that a relative arrangement of optical elements is different, the same members are denoted by the same reference numerals, and a description thereof is omitted.

Specifically, in the light source device 500 according to the present embodiment, the aspherical mirror 6, the fluorescent body unit 7, the first collimator lens 8 and the second collimator lens 9 are arranged in a central region.

The LD unit 1, the first lens 2, the rod integrator 3 and the second lens 4, and the flat mirror 5 are arranged at opposite sides of the central region.

That is, in the light source device 200 according to the first embodiment, the flat mirror 5 is arranged between the LD unit 1 and the fluorescent body unit 7 in the direction perpendicular to an emitting surface le of the LD unit 1.

On the other hand, in the light source device 500 according to the present embodiment, the fluorescent body unit 7 is arranged between the LD unit 1 and the flat mirror 5 in the direction perpendicular to the emitting surface le of the LD unit 1.

Thereby, in the light source device 500 according to the present embodiment, the blue light flux emitted from the LD unit 1 is incident on the flat mirror 5 arranged at the opposite side with the central region interposed therebetween by the first lens 2, the rod integrator 3 and the second lens 4.

Next, the blue light flux is condensed on the fluorescent body unit 7 by the aspherical mirror 6 after the flat mirror 5 reflects the blue light flux back toward the aspherical mirror 6 provided in the central region.

Then, the fluorescent light flux generated by absorbing a part of the blue light flux in the fluorescent body unit 7 is converted into a parallel light flux by passing through the second optical system to be incident on the illuminating optical system 210.

Further, the blue light flux diffusely reflected by the fluorescent body unit 7 is converted into a parallel light flux by passing through the first collimator lens 8 and the second region 9B of the second collimator lens 9 to be incident on the illuminating optical system 210.

As described above, in the light source device 500 according to the present embodiment, it is possible to achieve downsizing with maintaining a high utilization efficiency of fluorescent light by employing the above-described structure satisfying at least the conditional expression (1).

### Fifth Embodiment

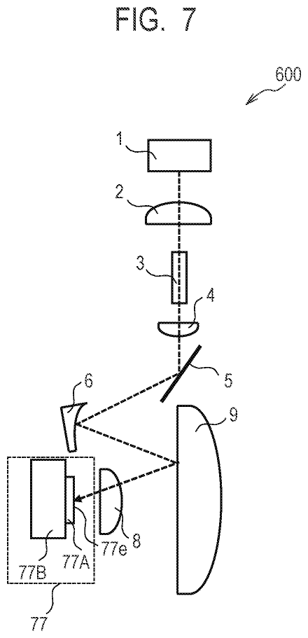

FIG. 7 shows a schematic cross-sectional view of a light source device 600 according to a fifth embodiment of the present invention.

Since the light source device 600 according to the present embodiment has the same structure as the light source device 200 according to the first embodiment except that an LED unit 77 is provided instead of the fluorescent body unit 7, the same members are denoted by the same reference numerals, and a description thereof is omitted.

As shown in FIG. 7, the LED unit 77 provided in the light source device 600 according to the present embodiment includes a fluorescent body 77A and a blue LED 77B.

The fluorescent body 77A is configured to emit fluorescent light having a wavelength different from that of incident blue light by absorbing a part of the incident blue light and to diffusely reflect a part of the incident blue light.

The blue LED 77B (a third light source) is arranged at a side opposite to an emitting surface 77e of the fluorescent body 77A, namely adjacent to a rear side of the fluorescent body 77A, and is configured to emit blue light toward the fluorescent body 77A.

That is, the blue LED 77B is arranged closer to the fluorescent body 77A than the first optical system and the second optical system.

Thereby, the blue light flux emitted from the LD unit 1 is condensed on the fluorescent body 77A by the first optical system in the light source device 600 according to the present embodiment.

Further, blue light emitted from the blue LED 77B is incident on the fluorescent body 77A.

Then, a fluorescent light flux generated by absorbing a part of each of the blue light flux and the blue light in the fluorescent body unit 7 is converted into a parallel light flux by passing through the second optical system to be incident on the illuminating optical system 210.

Further, the blue light flux diffusely reflected by the fluorescent body unit 7 is converted into a parallel light flux by passing through the first collimator lens 8 and the second region 9B of the second collimator lens 9 to be incident on the illuminating optical system 210.

As described above, in the light source device 600 according to the present embodiment, it is possible to achieve downsizing with maintaining a high utilization efficiency of fluorescent light by employing the above-described structure satisfying at least the conditional expression (1).

In addition, in the light source device 600 according to the present embodiment, it is possible to increase a light amount of fluorescent light generated by the fluorescent body 77A by providing the blue LED 77B as an auxiliary light source of blue light.

Although preferred embodiments have been described above, the present invention is not limited to these embodiments, and various modifications and changes can be made without departing from the scope of the present invention.

According to the present invention, it is possible to provide a light source device which can be downsized with maintaining a high utilization efficiency of fluorescent light.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-008451, filed Jan. 24, 2022, which is hereby incorporated by reference herein in its entirety.

What is claimed is:

1. A light source device comprising:
a first light source configured to emit a first light;
a wavelength conversion element configured to emit a second light with a wavelength different from the wavelength of the first light when the first light is incident on the wavelength conversion element;
a first optical system including a first reflecting element and configured to guide the first light from the first light source to the wavelength conversion element, the first reflecting element being configured to reflect the first light with condensing the first light; and
a second optical system configured to exert an optical action on the second light from the wavelength conversion element,
wherein a following conditional expression is satisfied:
3≤α≤30
where α [degrees] represents an angle between a straight line and an optical axis of the second optical system, the straight line passing through an intersection point between the optical axis of the second optical system and an exit surface of the wavelength conversion element, and a focal point of the first reflecting element.

2. The light source device according to claim 1, further comprising a color separator shared by the first optical system and the second optical system, the color separator including a first region configured to reflect the first light reflected by the first reflecting element and transmit the second light from the wavelength conversion element, and a second region configured to transmit the second light from the wavelength conversion element.

3. The light source device according to claim 2,
wherein the wavelength conversion element is configured to diffusely reflect a part of the first light from the first light source, and
wherein the second region is configured to transmit the first light diffusely reflected by the wavelength conversion element.

4. The light source device according to claim 2,
wherein the second optical system includes an optical element configured to convert the second light from the wavelength conversion element into a parallel light, and
wherein the color separator is provided on a surface of the optical element.

5. The light source device according to claim 1,
wherein the first optical system includes a second reflecting element configured to reflect the first light from the first light source toward the first reflecting element, and
wherein a following conditional expression is satisfied:
γ−2α−10≤β≤γ−2α+10
where β [degrees] represents an angle between an optical axis of the second reflecting element and the optical axis of the second optical system, and γ [degrees] represents an angle between an axis parallel to an incident direction of the first light on the second reflecting element and the optical axis of the second reflecting element.

6. The light source device according to claim 5, wherein the second reflecting element is arranged between the first light source and the wavelength conversion element in a direction perpendicular to an emitting surface of the first light source.

7. The light source device according to claim 5, wherein the wavelength conversion element is arranged between the first light source and the second reflecting element in a direction perpendicular to an emitting surface of the first light source.

8. The light source device according to claim 1, wherein the wavelength conversion element is a fluorescent body configured to emit a fluorescent light as the second light by absorbing at least a part of the first light.

9. The light source device according to claim 1, further comprising:
a second light source configured to emit a third light with a wavelength different from the wavelength of the first light; and
a third optical system configured to guide the third light from the second light source to the wavelength conversion element.

10. The light source device according to claim 9, further comprising a second reflecting element shared by the first optical system and the third optical system, and configured to reflect the first light from the first light source and transmit the third light from the second light source.

11. The light source device according to claim 9, wherein the wavelength conversion element is configured to diffusely reflect a part of the third light from the second light source.

12. The light source device according to claim 9, wherein the third light is an infrared light.

13. The light source device according to claim 1, wherein the first optical system includes:
a first lens configured to condense the first light from the first light source;
a rod integrator configured to make an intensity distribution of the first light uniform when the first light condensed by the first lens passes through the rod integrator; and
a second lens configured to convert the first light passing through the rod integrator into a parallel light.

14. The light source device according to claim 1, wherein the first optical system includes:
a first lens configured to condense the first light from the first light source;
a second lens configured to convert the first light condensed by the first lens into a parallel light; and
a light diffusing element configured to diffuse the first light passing through the second lens.

15. The light source device according to claim 13, wherein a following conditional expression is satisfied:
$$0.05 \leq \frac{f 2}{f 1} \leq 0.6$$
where f1 represents a focal length of the first lens, and f2 represents a focal length of the second lens.

16. The light source device according to claim 1, further comprising a third light source arranged closer to the wavelength conversion element than the first optical system and the second optical system, and configured to emit light toward the wavelength conversion element.

17. The light source device according to claim 16, wherein the light is blue light.

18. The light source device according to claim 1, wherein the first light is a blue light.

19. The light source device according to claim 1, wherein the first reflecting element includes an aspherical reflecting surface.

20. An image projecting apparatus comprising:
an image displaying element;
the light source device according to claim 1;
an illuminating optical system configured to guide the second light from the light source device to the image displaying element; and
a projecting optical system configured to guide image light from the image displaying element to a projected surface.
